(19) United States
(12) Patent Application Publication
(10) Pub. No.: US 2024/0024846 A1
(43) Pub. Date: Jan. 25, 2024

(54) SURFACE-MODIFIED ACTIVATED CARBON FOR REDUCED BACKWASHING FREQUENCY DURING PARTICULATE FILTRATION

(71) Applicant: CALGON CARBON CORPORATION, Moon Township, PA (US)

(72) Inventors: Adam M. REDDING, State College, PA (US); Rebecca L. DISTEFANO, Oakdale, PA (US)

(73) Assignee: CALGON CARBON CORPORATION, Moon Township, PA (US)

(21) Appl. No.: 18/358,447

(22) Filed: Jul. 25, 2023

Related U.S. Application Data
(60) Provisional application No. 63/369,285, filed on Jul. 25, 2022.

(51) Int. Cl. B01J 20/20; C01B 32/354; B01J 20/22; B01J 20/30; C02F 1/28

(52) U.S. Cl. CPC B01J 20/20; C01B 32/354; B01J 20/22; B01J 20/3085; C02F 1/283; C02F 2303/16

(57) ABSTRACT

There is provided herein a method of reducing the backwash frequency required in water treatment facilities which includes utilizing a surface-modified activated carbon. A method of preparing said surface-modified activated carbon is also provided. The method of preparing may include oxidizing an activated carbon with a chemical oxidant, which may result in surface functionalization of the activated carbon.

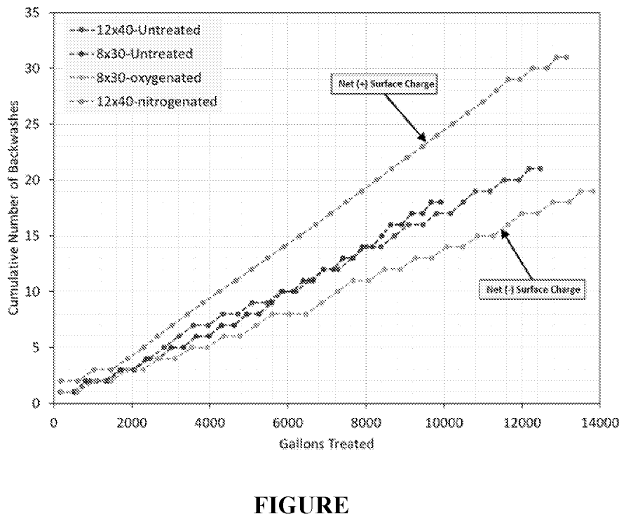

### CROSS-REFERENCE TO RELATED APPLICATIONS

This application claims priority to U.S. Provisional Patent Application No. 63/369,285, which was filed on Jul. 25, 2022, and is hereby incorporated by reference herein in its entirety.

### FIELD

The present disclosure relates generally to activated carbon for water treatment. More specifically, the present disclosure relates to the preparation of modified activated carbon for water treatment that reduces backwash frequency, thereby improving efficiency of the filtration plant.

### BACKGROUND

As a vital part of modern society, water treatment systems are known in the art and water treatment facilities have long benefitted from improving technologies. There has been a great deal of research directed towards improving the efficacy and efficiency of water treatment systems, with the design of new filtration materials and equipment allowing the removal of undesirable components from municipal and industrial water supplies. The filtration material used may vary depending on the contaminants to be removed and the end use of the water source.

Activated carbon is known in the art as an effective water treatment media. Typically sourced from raw organic materials such as coal, coconut shells, peat, or wood, activated carbon is capable of removing numerous contaminants from water via adsorption. Using activated carbon with different particle sizes and other filter components allows the removal of different contaminants, such as dissolved organic compounds, chlorine, hydrogen sulfide, bacteria, and other undesirable components. Methods of producing activated carbon are known in the art, and most typically involve thermal activation or chemical activation. During production, activated carbon may be prepared in such a way that yields specific physical properties, such as varying pore size and surface area, along with distinct chemical composition. These factors affect the performance of the resulting activated carbon filter, and thus the development of preparation methods that allow control of these variables are highly desirable.

Activated carbon filters may be reused for water filtration with appropriate maintenance. Backwashing is a maintenance strategy for reusable filter materials in order to remove particulate build-up and prevent filter failure, along with minimizing microbial growth in the filter. Typically, backwashing involves taking the filter offline and flushing clean water through the filter in the opposite direction of normal flow, dislodging particles that may be clogging the filter. The frequency with which backwashing is required varies depending on the specific type of filter and the level of contaminants removed during the water treatment process. Backwashing, while a necessary preventative maintenance step in prolonging filter operability, requires pausing the water treatment process and contributes to water waste.

There are numerous benefits to reducing backwash frequencies, including increasing the production capacity of the filtration plant and allowing less water to be wasted via the backwashing process. Methods to reduce backwashing frequency have included increasing the particle diameter and reducing the uniformity coefficient, both of which reduce the efficiency of particle removal during the water treatment process. The balance between reducing the frequency of backwashing and maintaining high efficiency of filter materials is crucial to the operation of water treatment facilities.

### SUMMARY

In some aspects, the techniques described herein relate to a method for modifying a surface of activated carbon, including contacting the activated carbon with a chemical oxidant to produce a surface-modified activated carbon.

In some aspects, the techniques described herein relate to a method, wherein the activated carbon is contacted with the chemical oxidant at a temperature of about 300° C. and about 700° C.

In some aspects, the techniques described herein relate to a method, wherein the activated carbon is contacted with the chemical oxidant at a temperature of about 350° C. and about 500° C.

In some aspects, the techniques described herein relate to a method, wherein the chemical oxidant is selected from the group consisting of air, oxygen, ozone, nitric acid, a peroxide, a peracid, a perborate, a persulfate, a perchlorate, and combinations thereof.

In some aspects, the techniques described herein relate to a method, wherein the chemical oxidant is in a gaseous form.

In some aspects, the techniques described herein relate to a method, wherein the chemical oxidant is air.

In some aspects, the techniques described herein relate to a method, wherein the chemical oxidant is oxygen.

In some aspects, the techniques described herein relate to a method, wherein the activated carbon is contacted with the chemical oxidant at a flow rate between about 2.5 and about 50 liters per minute.

In some aspects, the techniques described herein relate to a method, wherein the activated carbon is contacted with the chemical oxidant for a time between about five minutes and about three hours.

In some aspects, the techniques described herein relate to a method, wherein the contacting the activated carbon with the chemical oxidant occurs in a rotary kiln.

In some aspects, the techniques described herein relate to a method, wherein the rotary kiln has a rotary speed between about 1 and about 10 rotations per minute.

In some aspects, the techniques described herein relate to a method for preparing activated carbon such that a surface of the activated carbon is oxidized, resulting in functional groups on the surface of the activated carbon.

In some aspects, the techniques described herein relate to a method, wherein the functional groups include carboxylic groups, phenolic groups, or combinations thereof.

In some aspects, the techniques described herein relate to a method, wherein the functional groups may be deprotonated in aqueous solution to induce an overall net negative charge on the surface of the activated carbon.

In some aspects, the techniques described herein relate to a method for preparing a modified activated carbon such that when used in water filtration, treating 10,000 gallons of water with 0.9 gallons of the modified activated carbon requires 15 or fewer backwash cycles.

In some aspects, the techniques described herein relate to a method, wherein the method includes contacting the activated carbon with a chemical oxidant.

In some aspects, the techniques described herein relate to a method, wherein the activated carbon is contacted with the chemical oxidant at a temperature of about 300° C. and about 700° C.

In some aspects, the techniques described herein relate to a method, wherein the chemical oxidant is selected from the group consisting of air, oxygen, ozone, nitric acid, a peroxide, a peracid, a perborate, a persulfate, a perchlorate, and combinations thereof.

In some aspects, the techniques described herein relate to a method, wherein the activated carbon is contacted with the chemical oxidant at a flow rate between about 2.5 and about 50 liters per minute.

In some aspects, the techniques described herein relate to a method, wherein the activated carbon is contacted with the chemical oxidant for a time between about five minutes and about three hours.

### BRIEF DESCRIPTION OF THE DRAWINGS

Aspects, features, benefits and advantages of the embodiments described herein will be apparent with regard to the following description, appended claims, and accompanying drawings where:

The FIGURE is a graph depicting Gallons Treated vs. Cumulative Number of Backwashes as related to different activated carbon treatment procedures that produce different surface charges.

### DETAILED DESCRIPTION

This disclosure is not limited to the particular systems, devices and methods described, as these may vary. The terminology used in the description is for the purpose of describing the particular versions or embodiments only, and is not intended to limit the scope.

This disclosure describes examples of oxidizing the surface of activated carbon. In the following description, for the purposes of explanation, numerous specific details are set forth in order to provide a thorough understanding of the example embodiments. It will be evident to one skilled in the art that embodiments may be practiced without these specific details without deviating from the scope and spirit of this disclosure.

Activated carbon may be obtained from any known source, such as, but not limited to, bituminous coal, sub-bituminous coal, lignite coal, anthracite coal, wood, peat, nut shells, pits, coconut, babassu nut, macadamia nut, dende nut, peach pit, cherry pit, olive pit, walnut shell, wood, bagasse, rice hulls, corn husks, wheat hulls, polymers, resins, petroleum pitches, other carbonaceous material (for example extruded pellets), or any combination thereof. The source material of the activated carbon used as described herein is not particularly limited.

Activated carbon may be formed by processes well known in the art, for example, by carbonization and activation or by direct activation. For example, raw material such as wood, nutshell, coal, pitch, or the like, may be oxidized and devolatilized with steam and/or carbon dioxide gasified to form pore structures in a carbonaceous material, thereby creating adsorption sites. Oxidation and devolatilization processes may include, for example, a chemical treatment with a dehydrating chemical, such as phosphoric acid, boric acid, sulfuric acid, sodium hydroxide, potassium hydroxide, or any combination thereof. The method of preparing the activated carbon used as disclosed herein is not particularly limited.

The surface of the activated carbon may be oxidized during production to functionalize the activated carbon surface with functional groups such as carboxylic groups, phenolic groups, or combinations thereof that may be deprotonated in aqueous solution, yielding a net negative charge to the surface of the carbon. The negative surface charge may permit a deeper penetration of the captured particles into the bed of activated carbon during water treatment, without wishing to be bound by theory, allowing more of the activated carbon bed to participate in the filtration process and thereby increasing the overall particle filtration capacity of the system.

Utilizing oxidized activated carbon in water treatment can result in requiring fewer backwashes than unmodified activated carbon. Oxidized activated carbon requires 14 backwash cycles per 10,000 gallons of water treated, while unmodified activated carbon requires 18 backwash cycles per 10,000 gallons. While not wishing to be bound by theory, it is believed that the net negative surface charge and resulting charge repulsion is the aspect that allows this reduction in backwashing, as activated carbon that was prepared to have a net positive surface charge required 24 backwash cycles per 10,000 gallons. Reducing the frequency of backwash cycles allows the treatment system to remain operational longer and use less water than if frequent backwashing is required.

The FIGURE demonstrates the difference in backwash cycles required between untreated activated carbon, activated carbon that has been treated to have a net negative surface charge, and activated carbon that has been treated to have a net positive surface charge. As shown in the FIGURE, a 12×40-nitrogenated activated carbon with a net positive surface required a higher number of backwashes per gallons of water treated than a 12×4- or 8×30-untreated activated carbon. Conversely, an 8×30-oxygenated activated carbon with a net negative surface charge required fewer backwashes than the untreated carbons.

Oxidation of the activated carbon can be accomplished by contacting the carbon with any number of chemical oxidants including but not limited to air, oxygen, ozone, nitric acid, peroxides, peracids, perborates, persulfates, and perchlorates. The disclosed composition may be oxidized at a temperature between about 300° C. and about 700° C., or in some embodiments, between about 350° C. and about 500° C. For example, the activated carbon may be oxidized at a temperature of about 300° C., about 350° C., about 400° C., about 450° C., about 500° C., about 550° C., about 600° C., about 650° C., about 700° C., or any temperature contained within any range formed by any of the preceding values.

The activated carbon may be oxidized for a time between about five minutes and about three hours. For example, the activated carbon may be oxidized for a time of about 5 minutes, about 10 minutes, about 15 minutes, about 20 minutes, about 25 minutes, about 30 minutes, about 35 minutes, about 40 minutes, about 45 minutes, about 50 minutes, about 55 minutes, about 1 hour, about 1.5 hours, about 2 hours, about 2.5 hours, about 3 hours, or any time contained within any range formed by any of the preceding values. The oxidation may occur using a gaseous flow of oxidant having a flow rate between about 2.5 liters per minute and about 50 liters per minute (lpm), for example about 2.5 lpm, about 5 lpm, about 10 lpm, about 15 lpm, about 20 lpm, about 25 lpm, about 30 lpm, about 35 lpm, about 40 lpm, about 45 lpm, about 50 lpm, or any value contained within any range formed by any of the preceding values. The oxidation may be performed in a rotary kiln having rotation speeds between about 1 rotations per minute (rpm) and about 10 rpm, for example, about 1 rpm, about 2 rpm, about 3 rpm, about 4 rpm, about 5 rpm, about 6 rpm, about 7 rpm, about 8 rpm, about 9 rpm, about 10 rpm, or any value contained within any range formed by any of the preceding values.

The modified activated carbons disclosed herein may be useful in water treatment, without wishing to be bound by theory. Water treatment may include any water treatment process known to those skilled in the art, including but not limited to the removal of contaminants or desirable components.

In some embodiments, there is provided a method of preparing a modified activated carbon such that when used in water treatment, treating 10,000 gallons of water with 0.9 gallons of the modified activated carbon requires 15 or fewer backwash cycles. The method of preparing may include any of the method steps disclosed herein, such as contacting the activated carbon with a chemical oxidant.

In some embodiments, there is provided a method for modifying a surface of activated carbon, including contacting the activated carbon with a chemical oxidant to produce a surface-modified activated carbon.

In some embodiments, the activated carbon is contacted with the chemical oxidant at a temperature of about 300° C. and about 700° C.

In some embodiments, the activated carbon is contacted with the chemical oxidant at a temperature of about 350° C. and about 500° C.

In any of the above embodiments, the chemical oxidant is selected from the group consisting of air, oxygen, ozone, nitric acid, a peroxide, a peracid, a perborate, a persulfate, a perchlorate, and combinations thereof.

In any of the above embodiments, the chemical oxidant is in a gaseous form.

In any of the above embodiments, the chemical oxidant is air.

In any of the above embodiments, the chemical oxidant is oxygen.

In any of the above embodiments, the activated carbon is contacted with the chemical oxidant at a flow rate between about 2.5 and about 50 liters per minute.

In any of the above embodiments, the activated carbon is contacted with the chemical oxidant for a time between about five minutes and about three hours.

In any of the above embodiments, contacting the activated carbon with the chemical oxidant occurs in a rotary kiln.

In any of the above embodiments, the rotary kiln has a rotary speed between about 1 and about 10 rotations per minute.

There is provided a method for preparing activated carbon such that a surface of the activated carbon is oxidized, resulting in functional groups on the surface of the activated carbon.

In some embodiments, the functional groups include carboxylic groups, phenolic groups, or combinations thereof.

In any of the above embodiments, the functional groups may be deprotonated in aqueous solution to induce an overall net negative charge on the surface of the activated carbon.

There is provided a method for preparing a modified activated carbon such that when used in water treatment, treating 10,000 gallons of water with 0.9 gallons of the modified activated carbon requires 15 or fewer backwash cycles.

In some embodiments, the method includes contacting the activated carbon with a chemical oxidant.

In any of the above embodiments, the activated carbon is contacted with the chemical oxidant at a temperature of about 300° C. and about 700° C.

In any of the above embodiments, the chemical oxidant is selected from the group consisting of air, oxygen, ozone, nitric acid, a peroxide, a peracid, a perborate, a persulfate, a perchlorate, and combinations thereof.

In any of the above embodiments, the activated carbon is contacted with the chemical oxidant at a flow rate between about 2.5 and about 50 liters per minute.

In any of the above embodiments, the activated carbon is contacted with the chemical oxidant for a time between about five minutes and about three hours.

Those skilled in the art will understand the term “air” to describe the typical composition of ambient air, which comprises a mixture of gaseous nitrogen, oxygen, carbon dioxide, and other gases. Those skilled in the art will understand that “air” is not restricted to an exact composition, and that variations in the composition of air, such as those that may occur at changing elevations, fall within the scope of this disclosure.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the FIGURES, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations.

As used herein, the term “about” means plus or minus 10% of the numerical value of the number with which it is being used. Therefore, about 50% means in the range of 45%-55%/

In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A method for modifying a surface of activated carbon, comprising contacting the activated carbon with a chemical oxidant to produce a surface-modified activated carbon.

2. The method of claim 1, wherein the activated carbon is contacted with the chemical oxidant at a temperature of about 300° C. and about 700° C.

3. The method of claim 1, wherein the activated carbon is contacted with the chemical oxidant at a temperature of about 350° C. and about 500° C.

4. The method of claim 1, wherein the chemical oxidant is selected from the group consisting of air, oxygen, ozone, nitric acid, a peroxide, a peracid, a perborate, a persulfate, a perchlorate, and combinations thereof.

5. The method of claim 1, wherein the chemical oxidant is in a gaseous form.

6. The method of claim 1, wherein the chemical oxidant is air.

7. The method of claim 1, wherein the chemical oxidant is oxygen.

8. The method of claim 1, wherein the activated carbon is contacted with the chemical oxidant at a flow rate between about 2.5 and about 50 liters per minute.

9. The method of claim 1, wherein the activated carbon is contacted with the chemical oxidant for a time between about five minutes and about three hours.

10. The method of claim 1, wherein the contacting the activated carbon with the chemical oxidant occurs in a rotary kiln.

11. The method of claim 10, wherein the rotary kiln has a rotary speed between about 1 and about 10 rotations per minute.

12. A method for preparing activated carbon such that a surface of the activated carbon is oxidized, resulting in functional groups on the surface of the activated carbon.

13. The method of claim 12, wherein the functional groups comprise carboxylic groups, phenolic groups, or combinations thereof.

14. The method of claim 12, wherein the functional groups may be deprotonated in aqueous solution to induce an overall net negative charge on the surface of the activated carbon.

15. A method for preparing a modified activated carbon such that when used in water treatment, treating 10,000 gallons of water with 0.9 gallons of the modified activated carbon requires 15 or fewer backwash cycles.

16. The method of claim 15, wherein the method comprises contacting the activated carbon with a chemical oxidant.

17. The method of claim 16, wherein the activated carbon is contacted with the chemical oxidant at a temperature of about 300° C. and about 700° C.

18. The method of claim 16, wherein the chemical oxidant is selected from the group consisting of air, oxygen, ozone, nitric acid, a peroxide, a peracid, a perborate, a persulfate, a perchlorate, and combinations thereof.

19. The method of claim 16, wherein the activated carbon is contacted with the chemical oxidant at a flow rate between about 2.5 and about 50 liters per minute.

20. The method of claim 16, wherein the activated carbon is contacted with the chemical oxidant for a time between about five minutes and about three hours.
